(19) United States
(12) Patent Application Publication
(10) Pub. No.: US 2009/0047094 A1
(43) Pub. Date: Feb. 19, 2009

(54) Tolerance compensating fastener

(76) Inventors: Roger Derrick Stone, Tervuren (BE); Ralph Emery, Bridgnorth (GB)

Correspondence Address: THE GATES CORPORATION, IP LAW DEPT. 10-A3, 1551 WEWATTA STREET, DENVER, CO, 80202, US

(21) Appl. No.: 11/891,895

(22) Filed: Aug. 14, 2007

(51) Int. Cl. F16B 21/18; E05C 19/06; F16B 37/12

(52) U.S. Cl. 411/352; 292/83; 411/178

(57) ABSTRACT

A tolerance compensating fastener comprising a first member having a first member bore and an outer surface having threads, a second member having a second member bore and a spherical portion engaged with the first member, a third member having threads and disposed through the first member bore and the second member bore, the third member threads engagable with a first mounting portion, a fourth member engaged between the first member and the third member, the fourth member transmits a torque from the third member to the first member whereby the first member is rotated from a second mounting portion toward the first mounting portion, and the second member disposed between the first member and the first mounting portion.

### FIELD OF THE INVENTION

The invention relates to a tolerance compensating fastener, and more particularly, to a tolerance compensating fastener having a spherical member.

### BACKGROUND OF THE INVENTION

Devices are known that effect the clamping attachment of spaced structural parts by means of a connecting screw and a distance portion which is arranged in said space, that rests with an outer broad side against the one structural part and is equipped with helically lying ascent support surfaces, and opposite which there are form-fitting helical mating ascent support surfaces associated with the other structural part, and in which connection the turning of the support surfaces with respect to each other determines the maximum measurement assumed, in the manner that the distance plate is driven into its resting position by connection with the outer surface of the connecting screw.

Representative of the art is U.S. Pat. No. 7,048,487 (2006) to Stone which discloses a connector comprising an adapter having a threaded bore and a bushing having an external thread and an internal thread. The adapter has a stop on an outer surface to prevent rotation. The bushing is threaded into the adapter bore. A bolt is threaded into a bushing bore using the internal threads. As the bolt is turned the internal threads cause an interference fit between the bolt shank and the threads, temporarily preventing further insertion of the bolt. The bolt is then turned further causing the bushing to unscrew from the adapter toward the mounting surface until the bushing bears upon the mounting surface. The adapter engages with part thereby completely compensating for a gap between the part and a mounting surface. The adapter does not turn through engagement of the stop with an immoveable part. As the bolt is turned further, the sacrificial internal threads are stripped to allow the bolt to be fully torqued into a mounting surface hole.

What is lacking is a fastener that comprises a spherical member for automatic adjustment of alignment of the fastener members.

What is needed is a tolerance compensating fastener having a spherical member for automatic alignment of the members. The present invention meets this need.

### SUMMARY OF THE INVENTION

The primary aspect of the invention is to provide a tolerance compensating fastener having a spherical member for automatic alignment of the members.

Other aspects of the invention will be pointed out or made obvious by the following description of the invention and the accompanying drawings.

The invention comprises a tolerance compensating fastener comprising a first member having a first member bore and an outer surface having threads, a second member having a second member bore and a spherical portion engaged with the first member, a third member having threads and disposed through the first member bore and the second member bore, the third member threads engagable with a first mounting portion, a fourth member engaged between the first member and the third member, the fourth member transmits a torque from the third member to the first member whereby the first member is rotated from a second mounting portion toward the first mounting portion, and the second member disposed between the first member and the first mounting portion.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross-sectional view of the tolerance compensating fastener.

FIG. 2 is a cross-sectional view of the tolerance compensating fastener.

FIG. 3 is a cross-sectional view of the tolerance compensating fastener.

FIG. 4 is a graph of the torque versus stage of the tightening sequence for the tolerance compensating fastener.

### DETAILED DESCRIPTION OF THE PREFERRED EMBODIMENT

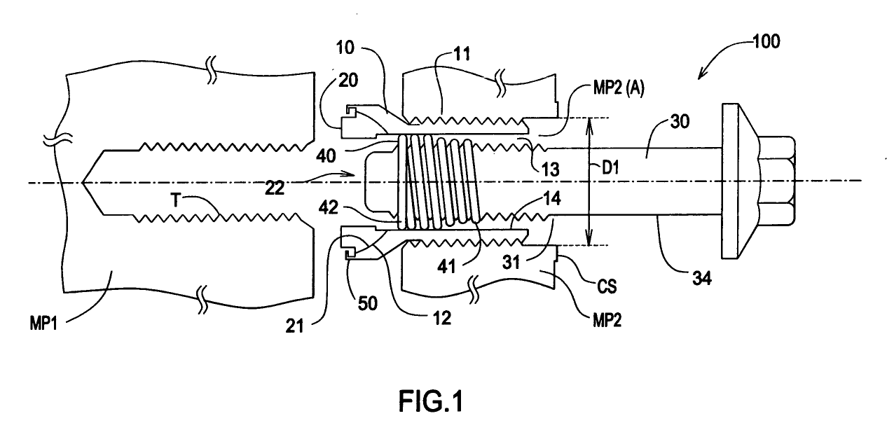

FIG. 1 is a cross-sectional view of the tolerance compensating fastener.

Fastener 100 comprises a first member 10. First member 10 is cylindrical and has threads 11 disposed on an outer surface. Threads 11 are typically right hand threads. First member 10 also comprises a bore 13.

Second member 20 comprises a surface 21 having a partial spherical shape. Surface 21 engages surface 12 of first member 10. Surface 21 and surface 12 each comprise substantially the same shape to enhance engagement between them when the fastener is in use. The shape of surfaces 21, 12 is that of a portion of a sphere for ease of manufacture. However, any other shape having a curved characteristic may be used with equal success. The curved form of surface 12, 21 allows for the first member and second member to self align during installation while maintaining a secure engagement between the second member and a surface of first mounting portion MP1. Second member 20 further comprises a bore 22 through which third member 30 is engaged. For an “all-plane” alignment capability the curved shape of surfaces 12, 21 is preferably spherical.

A clasping member 50 holds second member 20 in contact with the first member 10 when the fastener 100 is not in use, for example, during storage. Clasping member 50 connects to first member 10. Clasping member 50 is then sprung slightly open as second member 20 is pressed into engagement with the first member 10.

Third member 30 comprises a bolt having threads 31 disposed on an outer surface. Bolts are known in the art. Threads 31 threadably engage threads T in a first mounting portion MP1. Threads 31 are right hand threads.

Fourth member 40 is engaged between the first member 10 and the third member 30. Fourth member 40 engages threads 31 and the inner surface of first member 10. Fourth member comprises a coiled wire, such as a spring. A first diameter is selected to allow first end 41 to grippingly engage threads 31. A second diameter is selected to allow a second end 42 to frictionally engage inner surface 14 of first member 10.

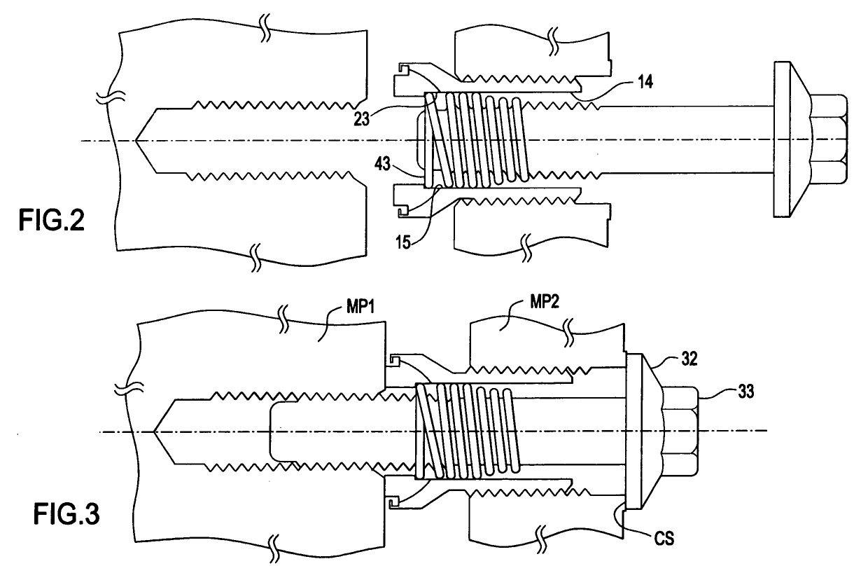

FIG. 2 is a cross-sectional view of the tolerance compensating fastener. In this FIG. 2 an alternate embodiment of the second member 20 and the fourth member 40 is described.

Namely, end 43 of fourth member 40 is somewhat extended so that it can frictionally engage a bore feature 23. Bore feature 23 comprises a lip with which end 43 may cooperatively engage. Clasping member 50 is absent in this embodiment since fourth member end 43 frictionally engages bore feature 23.

First member 10 further comprises a lip 15 which extends around and projects radially inward from inner surface 14. Lip 15 is for engaging fourth member end 43. Lip 15 prevents fourth member end 43 from loosing a grip on first member 10 as third member 30 is turned.

FIG. 3 is a cross-sectional view of the tolerance compensating fastener. Fastener 100 is shown fully engaged between first mounting portion MP1 and second mounting portion MP2. A flange 32 on third member 30 is engaged with second mounting portion MP2. Portion 33 is for engaging a tool such as a wrench or ratchet.

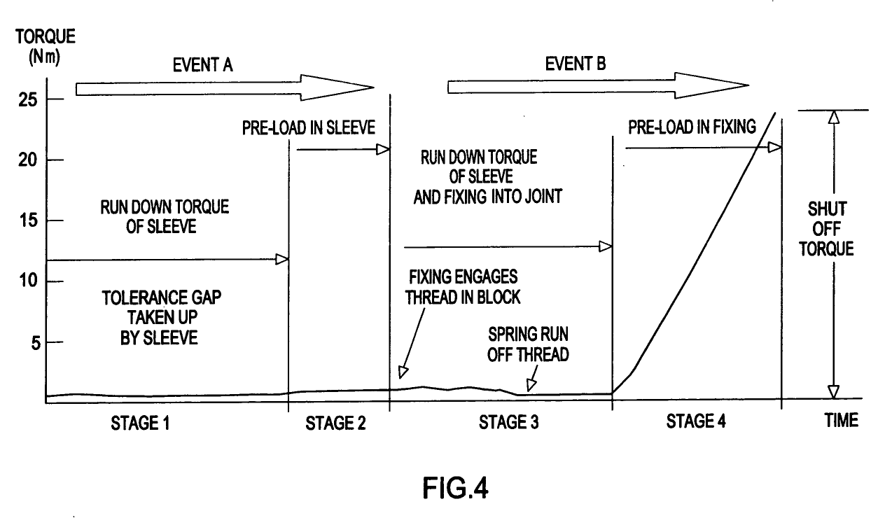

FIG. 4 is a graph of the torque versus stage of the tightening sequence for the tolerance compensating fastener.

A typical application for the fastener would be, for example, the case where a bracket has to be bolted rigidly to two or more separate castings that cannot be machined as an assembly. Consequently there are unavoidable tolerance stacks which traditionally may have to be shimmed. Another case may be where there is a requirement to add a reinforcing fixing perpendicular to the plane of the other fixings on a given component—in this case it may even be required to leave a significant clearance which has to be shimmed. Application of the fastener 100 requires only that the hole(s) MP2 (A) in the second mounting portion have a larger diameter (D1) than conventionally would be used and that it be tapped with the appropriate thread to match with threads 11.

The assembly process is very simple; the complete fastener system is delivered as shown in FIG. 1 and the assembly without the third member 30, namely, the first member 10 and second member 20, is initially screwed into the large diameter hole MP2(A) in the second mounting portion MP2. The second mounting portion MP2 is then offered to the first mounting portion MP1 and any conventional fasteners (if any) are tightened first. Then any fastener's 100 are tightened. A nut runner tool (not shown) is applied to the bolt head 33 and started. Bolt 30 turns and the friction between the fourth member 40 and the bolt threads 31 is such that the entire fastener 100 turns in the large diameter hole MP2 (A) (event A stage 1 in FIG. 4). This continues until the free end of the second member 20 touches the surface of the first mounting portion MP1 (event A stage 2 in FIG. 4), at which point the bolt 30 will start to turn inside the fourth member 40. This is the condition shown in event B stage 3 of FIG. 4. It is important that, at this point, first member 10 has passed far enough into the second mounting portion hole MP2 (A) not to protrude above the clamping surface (CS). Bolt 30 now drives through the fourth member 40 until it engages with the thread T in the first mounting portion MP1. Any “fight” between the pitch position of the thread T and the fourth member is simply taken up by axial movement in the fourth member.

Bolt 30 now continues to engage with the thread T while the fourth member 40 runs off the end of the bolt thread 31 onto the smaller, rolling diameter of the bolt shank 34. Thus the fourth member drag torque drops to a very low level. Further driving the bolt 30 results in an entirely conventional tightening process and the final positions are shown in stage 4 of FIG. 4. FIG. 3 is a cross-section view of the tolerance compensating fastener fully installed. However, the second mounting portion, which would have otherwise had a clearance to the first mounting portion due to stacked tolerances has been bolted securely with no distortion or bending stresses.

Although forms of the invention has been described herein, it will be obvious to those skilled in the art that variations may be made in the construction and relation of parts and method without departing from the spirit and scope of the invention described herein.

We claim:

1. A tolerance compensating fastener comprising:
a first member having a first member bore and an outer surface having threads;
a second member having a second member bore and a spherical portion engaged with the first member;
a third member having threads and disposed through the first member bore and the second member bore, the third member threads engagable with a first mounting portion;
a fourth member engaged between the first member and the third member, the fourth member transmits a torque from the third member to the first member whereby the first member is rotated from a second mounting portion toward the first mounting portion; and
the second member disposed between the first member and the first mounting portion.

2. The tolerance compensating fastener as in claim 1, wherein the fourth member comprises a spring.

3. The tolerance compensating fastener as in claim 1, wherein the third member comprises a bolt.

4. The tolerance compensating fastener as in claim 1, wherein the outer surface threads comprise right hand thread.

5. The tolerance compensating fastener as in claim 1, wherein:
the second member further comprises a bore feature to frictionally engage the fourth member; and
the first member further comprises a lip projecting radially inward from a bore inner surface for engaging the fourth member.

6. The tolerance compensating fastener as in claim 1 further comprising a clasping member for holding the second member in predetermined relation to the first member.

7. The tolerance compensating fastener as in claim 1, wherein the first member further comprises a spherical surface for cooperatively engaging the spherical surface of the second member.
